(19) United States
(12) Patent Application Publication
(10) Pub. No.: US 2015/0131561 A1
(43) Pub. Date: May 14, 2015

(54) METHOD FOR TRANSMITTING AND RECEIVING DATA BY USING AN EXISTING CONNECTION LINK IN A WIRELESS COMMUNICATIONS SYSTEM AND AN APPARATUS FOR THE SAME

(71) Applicant: LG ELECTRONICS INC., Seoul (KR)

(72) Inventors: Jiwoong Jang, Anyang-si (KR); Dongcheol Kim, Anyang-si (KR); Hangyu Cho, Anyang-si (KR); Jiwon Kang, Anyang-si (KR); Sungho Park, Anyang-si (KR); Dongguk Lim, Anyang-si (KR)

(73) Assignee: LG ELECTRONICS INC., Seoul (KR)

(21) Appl. No.: 14/402,269

(22) PCT Filed: Jun. 3, 2013
(86) PCT No.: PCT/KR2013/004871

§ 371 Date: Nov. 19, 2014

Related U.S. Application Data
(60) Provisional application No. 61/654,092, filed on Jun. 1, 2012.
(60) Provisional application No. 61/656,531, filed on Jun. 7, 2012.

(51) Int. Cl. H04W 76/02

(52) U.S. Cl. CPC H04W 76/02
USPC 370/329

(57) ABSTRACT

The method for enabling a first mobile terminal connected to a first storage terminal to send data to a second storage terminal connected to a second mobile terminal in a wireless communications system includes the steps of: receiving the information of the data to be transmitted from the first storage terminal to the second storage terminal; transmitting the information of the data through a link connected to the second mobile terminal to the second mobile terminal; receiving the information of the second storage terminal from the second mobile terminal; determining whether it is possible to transmit the data through the link based on the information of the data and the information of the second storage terminal; and if it is possible to transmit the data, transmitting the data received from the first storage terminal through the link to the second mobile terminal

### FIELD OF THE INVENTION

The present invention relates to a wireless communication system and, more particularly, to a method for transmitting data (contents) from a first storage terminal connected to a first mobile terminal to a second mobile terminal connected to a second storage terminal in a wireless communication system.

### BACKGROUND ART

Wireless communication systems are being broadly developed in order to provide various types of communication services, such as voice or data services.

Generally, a wireless communication system corresponds to a multiple access system that may support communication with multiple users by sharing an available system source (bandwidth, transmission power, and so on).

Examples of a multiple access system include a CDMA (code division multiple access) system, an FDMA (frequency division multiple access) system, a TDMA (time division multiple access) system, an OFDMA (orthogonal frequency division multiple access) system, an SC-FDMA (single carrier frequency division multiple access) system, an MC-FDMA (multi-carrier frequency division multiple access), and so on.

### DETAILED DESCRIPTION OF THE INVENTION

### Technical Objects

An object of the present invention is to provide a method for transmitting data from a first storage terminal connected to a first mobile terminal to a second mobile terminal connected to a second storage terminal in a wireless communication system. Another object of the preset invention is to provide a method for efficiently transmitting data by using an existing link between a first mobile terminal and a second mobile terminal.

The technical objects that are to be achieved in the present invention will not be limited only to the objects described above, and other technical objects that have not been mentioned above may be taken into consideration by anyone skilled in the art to which the present invention belongs based upon exemplary embodiments of the present invention that will hereinafter be described in detail.

### Technical Solutions

In order to resolve the technical object of the present invention, according to an exemplary embodiment of the present invention, a method of a first mobile terminal being connected to a first storage terminal for transmitting data to a second storage terminal being connected to a second mobile terminal in a wireless access system may include a step of receiving information on the data being transmitted to the second storage terminal from the first storage terminal; a step of transmitting information on the data to the second mobile terminal through a link being connected to the second mobile terminal; a step of receiving information on the second storage terminal from the second mobile terminal through the link; a step of determining whether or not the data transmission is capable of being performed through the link based upon the information on the data and the information on the second storage terminal; and, when the data transmission is capable of being performed, a step of transmitting the data being received from the first storage terminal to the second mobile terminal through the link.

The step of transmitting data may include a step of transmitting the data through the link along with pre-existing data, the already-existing data being configured for a function already being performed through the link.

The method may further include, when data transmission is not capable of being performed through the link, a step of having the first storage terminal configure a new link being capable of transmitting the data to the second storage terminal.

The first mobile terminal may be connected to the first storage terminal through a first local network, the second mobile terminal may be connected to the second storage terminal through a second local network, and the first mobile terminal may be connected to the second mobile terminal through a broadband network.

The first mobile terminal may communicate with the first storage terminal through at least one of Wi-Fi Direct, NFC (near field communication), Zigbee, and bluethooth.

The first mobile terminal may acquire information on the data by reading a QR code (Quick Response Code) or a Barcode being attached to the first storage terminal.

The first mobile terminal may acquire information on the data by reading a RFID (Radio Frequency Identification) tag being attached to the first storage terminal by using a RFID reader.

The information on the data may include at least one of a file name of the data, a file size of the data, and a playback record of the data.

When the data transmission is capable of being performed, the step of transmitting data may transmit the data after receiving an ACK (acknowledgement) message from the second storage terminal through the second mobile terminal.

According to another exemplary embodiment of the present invention, a mobile terminal configured to transmit data being stored in a first storage terminal to a second storage terminal being connected to a second mobile terminal may include a radio frequency (RF) unit including a transmitter and a receiver; and a processor, wherein the processor may be configured to receive information on the data that are to be transmitted to the second storage terminal from the first storage terminal, to transmit information on the data to the second mobile terminal through a link being connected to the second mobile terminal, to receive information on the second storage terminal from the second mobile terminal, to determine whether or not the data transmission is capable of being performed through the link based upon the information on the data and the information on the second storage terminal, and to transmit the data being received from the first storage terminal to the second mobile terminal through the link, when the data transmission is capable of being performed.

The data may be transmitted through the link along with pre-existing data, the already-existing data being configured for a function already being performed through the link.

The first storage terminal may be configured to establish a new link being capable of transmitting the data to the second storage terminal, when data transmission is not capable of being performed through the link.

The mobile terminal may be connected to the first storage terminal through a first local network, the second mobile terminal may be connected to the second storage terminal through a second local network, and the mobile terminal may be connected to the second mobile terminal through a broadband network.

The first mobile terminal may communicate with the first storage terminal through at least one of Wi-Fi Direct, NFC (near field communication), Zigbee, and bluethooth.

The first mobile terminal may acquire information on the data by reading a QR code (Quick Response Code) or a Barcode being attached to the first storage terminal.

The first mobile terminal may acquire information on the data by reading a RFID (Radio Frequency Identification) tag being attached to the first storage terminal by using a RFID reader.

The information on the data may include at least one of a file name of the data, a file size of the data, and a playback record of the data.

A general description of present invention, which is provided above, and the detail description of the present invention that will hereinafter be provided are merely exemplary and, therefore, provided for additional description of the appended claims of the present invention.

### Effects of the Invention

According to the present invention, a method for transmitting data from a first storage terminal connected to a first mobile terminal to a second mobile terminal connected to a second storage terminal in a wireless communication system may be provided, and, most particularly, a method for efficiently transmitting data by using an existing link between a first mobile terminal and a second mobile terminal may be provided.

The effects that can be achieved in the present invention will not be limited only to the effects described above, and other effects that have not been mentioned above may be clearly understood by anyone skilled in the art to which the present invention belongs based upon exemplary embodiments of the present invention that will hereinafter be described in detail.

### BRIEF DESCRIPTION OF THE DRAWINGS

The appended drawings shown below are provided to facilitate the understanding of the present invention, and the appended drawings provide exemplary embodiments of the present invention along with the respective detailed description. However, the technical characteristics of the present invention will not be limited only to the specific drawings provided below, and the characteristics disclosed in each of the drawings may be combined with one another so as to configure a new exemplary embodiment.

FIG. 1 illustrates an exemplary network structure to which the present invention can be applied.

FIG. 2 illustrates a flow chart shows a data transmission method according to an exemplary embodiment of the present invention.

FIG. 3 illustrates a flow chart shows a data transmission method according to an exemplary embodiment of the present invention.

FIG. 4 illustrates a flow chart shows a data transmission method according to an exemplary embodiment of the present invention.

FIG. 5 illustrates a flow chart shows a data transmission method according to an exemplary embodiment of the present invention.

FIG. 6 illustrates a flow chart shows a data transmission method according to an exemplary embodiment of the present invention.

FIG. 7 illustrates a flow chart shows a data transmission method according to an exemplary embodiment of the present invention.

FIG. 8 illustrates a flow chart shows a data transmission method according to an exemplary embodiment of the present invention.

FIG. 9 illustrates a flow chart shows a data transmission method according to an exemplary embodiment of the present invention.

FIG. 10 illustrates a flow chart shows a data transmission method according to an exemplary embodiment of the present invention.

FIG. 11 illustrates a flow chart shows a data transmission method according to an exemplary embodiment of the present invention.

FIG. 12 illustrates a block view of an exemplary wireless access system according to an exemplary embodiment of the present invention.

### MODE FOR CARRYING OUT THE INVENTION

The exemplary embodiments of the present invention respectively provide methods for transmitting data from a first storage terminal connected to a first mobile terminal to a second mobile terminal connected to a second storage terminal in a wireless communication system and devices supporting the same.

The embodiments described below correspond to predetermined combinations of elements and features and characteristics of the present invention. Moreover, unless mentioned otherwise, the characteristics of the present invention may be considered as optional features of the present invention. Herein, each element or characteristic of the present invention may also be operated or performed without being combined with other elements or characteristics of the present invention. Alternatively, the embodiment of the present invention may be realized by combining some of the elements and/or characteristics of the present invention. Additionally, the order of operations described according to the embodiment of the present invention may be varied. Furthermore, part of the configuration or characteristics of any one specific embodiment of the present invention may also be included in (or shared by) another embodiment of the present invention, or part of the configuration or characteristics of any one embodiment of the present invention may replace the respective configuration or characteristics of another embodiment of the present invention.

In order to avoid any ambiguity in the concept (or idea) of the present invention, some of the structures and devices disclosed (or mentioned) in the present invention may be omitted from the description of the accompanying drawings of the present invention. Also, any procedure or step that can be easily understood by anyone skilled in the art has also been excluded from the description of the present invention.

The exemplary embodiments of the present invention may be supported by the standard documents that are disclosed in at least any one of the diverse wireless access systems, such as an IEEE 802 system, a 3GPP system, a 3GPP LTE system, an LTE-A (LTE-Advanced) system, and a 3GPP2 system. More specifically, among the exemplary embodiments of the present invention, reference may be made to the above-mentioned documents for the description of obvious process steps or elements of the present invention that have not been described herein in order to clearly show the technical spirit of the present invention.

The technology described below may be used in a wide range of wireless access systems, such as CDMA (code division multiple access), FDMA (frequency division multiple access), TDMA (time division multiple access), OFDMA (orthogonal frequency division multiple access), SC-FDMA (single carrier frequency division multiple access), and so on. Herein, the CDMA may be realized by a radio technology such as UTRA (Universal Terrestrial Radio Access) or CDMA2000. The TDMA may be realized by a radio technology such as GSM (Global System for Mobile communications)/GPRS (General Packet Radio Service)/EDGE (Enhanced Data Rates for GSM Evolution). The OFDMA may be realized by a radio technology such as IEEE 802.11 (Wi-Fi), IEEE 802.16 (WiMAX), IEEE 802-20, E-UTRA (Evolved UTRA), and so on. The UTRA corresponds to a portion of the UMTS (Universal Mobile Telecommunications System). And, as a portion of the E-UMTS (Evolved UMTS) using the E-UTRA, the 3GPP (3rd Generation Partnership Project) LTE (long term evolution) system adopts the OFDMA in a downlink and adopts the SC-FDMA in an uplink. The LTE-A (LTE-Advanced) corresponds to an evolution of the 3GPP LTE system.

Hereinafter, the preferred exemplary embodiment according to the present invention will be described in detail with reference to the accompanying drawings. The detailed description that is to be disclosed along with the appended drawings merely corresponds to the description of the exemplary embodiments of the present invention, and, therefore, it is not intended to represent a sole exemplary embodiments that may be realized by the present invention.

Reference will now be made in detail to the preferred embodiments of the present invention, examples of which are illustrated in the accompanying drawings, so that anyone skilled in the art can easily implement the embodiments of the present invention. However, it will be apparent that the present invention may be implemented in a variety of different structures, and, therefore, the present invention will not be limited only to the exemplary embodiments presented herein. Furthermore, in the accompanying drawings, in order to clearly describe the embodiments of the present invention, any parts irrelevant to the description of the present invention will be omitted. And, wherever possible, similar reference numbers will be used throughout the drawings to refer to the same or like parts.

Throughout the entire description of the present invention, when a particular part is said to “comprise (or include)” a specific element, unless specifically written or indicated otherwise, this does not signify that another element is excluded from the specific part but signifies that the specific part may also include other elements. Also, terms such as “. . . unit”, “. . . device”, “. . . module”, and so on, which are indicated in the description of the present invention, indicates units that process at least one function or operation. And, this may be realized in the form of hardware or software, or a combination of hardware and software.

The specific terms used in the following embodiments of the present invention are provided to facilitate the understanding of the present invention. And, therefore, without deviating from the technical scope and spirit of the present invention, such specific terms may also be changed to other terms.

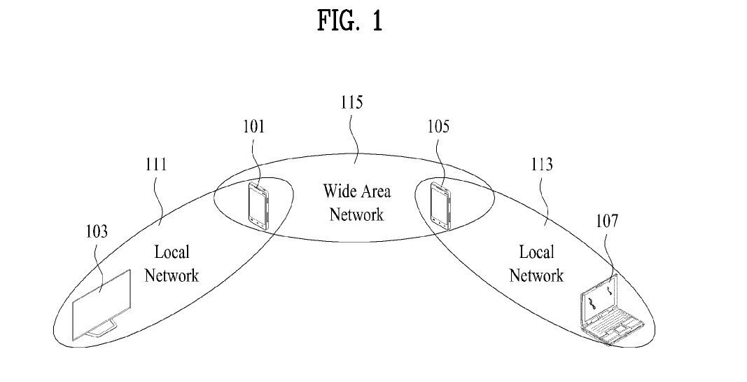

FIG. 1 illustrates an exemplary network structure to which the present invention can be applied.

Referring to FIG. 1, a first mobile terminal (101) is connected to a first storage terminal (103) through a local network (111), and a second mobile terminal (105) is connected to a second storage terminal (107) through a local network (113), and the first mobile terminal (101) may be connected to the second mobile terminal (105) through a broadband network (or wide area network) (115). Additionally, in FIG. 1, although it is illustrated that 2 mobile terminals each being connected to a local network are connected to one another through a broadband network, the present invention will not be limited only to this and 3 or more mobile terminals may be connected to the broadband network.

In this specification, a local network refers to a communication network connecting terminals, computers, electronic devices, and so on, each being located within comparatively close range to one another, and examples of the local network may include Wi-Fi Direct, NFC (near field communication), Zigbee, bluethooth, and so on. A broadband network refers to a network providing communication at long distances (or remote distances), and an example of the broadband network may correspond to a cellular network. However, although it is shown in FIG. 1 that the first mobile terminal is connected to the second mobile terminal through the broadband network, the present invention will not be limited only to this, and the first mobile terminal may also be connected through another form of network (e.g., local network).

Most particularly, in case the first mobile terminal performs video conference connection with a second mobile terminal, which is located at a remote location, the present invention may be capable of efficiently providing content. At this point, the content that is being transmitted to the second mobile terminal may be stored in the first storage terminal, and the first mobile terminal may received the content from the first storage terminal and may then transmit the received content to the second mobile terminal. Similarly, the second mobile terminal may transmit the content received from the first mobile terminal to the second storage terminal through a local network.

In case of the related art, when the first mobile terminal transmits content stored in the first storage terminal to the second mobile terminal, either the content was transmitted by configuring a new link with the second mobile terminal regardless of the presence or absence of an existing link, or a method of uploading content to a shared database over the Internet was used. More specifically, according to the related art method, an additional process of configuring (or setting up) a new link in order to transmit content was required. Hereinafter, a method of easily transmitting and/or receiving content by using a pre-connected link between the first mobile terminal and the second mobile terminal will be described.

According to the present invention, the first mobile terminal may transmit content to the second mobile terminal by using a pre-connected link. For example, in case the first mobile terminal is maintaining a link connected for performing voice phone calls, video phone calls, and so on, within the second mobile terminal, the first mobile terminal may transmit content through the link, which is connected in order to perform a voice phone call or a video phone call. In this case, it is advantageous in that additional procedures for setting up a new link in order to transmit content can be omitted.

In order to verify whether or not content can be transmitted to the second mobile terminal through a pre-connected link and to perform set-up, the first mobile terminal may transmit/receive set-up information to/from the second mobile terminal. The set-up information may include at least one of information on a terminal that is to participate in content transmission, information on the content that is being transmitted, and information on a pre-connected link. The information on a terminal that is to participate in content transmission may include a terminal identifier that can identify a terminal. The information on the content that is being transmitted may include a file name of the content, a data size, content that is currently being played, and so on. The information on a pre-connected link refers to information on a link through which the first mobile terminal and the second mobile terminal are connected, and the information on a pre-connected link corresponds to information on a link respective to a voice phone call or a video phone call. In case 3 or more mobile terminals are connected to a broadband network, the set-up information may further include information on a number of terminals that are to receive content.

In case the content that is to be transmitted to the second mobile terminal is stored in the first storage terminal, which is connected to the first mobile terminal through a local network, the first mobile terminal may receive information on the content from the first storage terminal. At this point, the first mobile terminal may also receive information on the content though a local network or by using another type of link. For example, the first mobile terminal may receive information on the content by scanning codes, such as a QR code (Quick Response Code) or a Barcode, which is attached to the first storage terminal. Additionally, the first mobile terminal may also receive information on the content from an RFID tag, which is attached to the first storage terminal by using an RFID (Radio Frequency Identification) Reader. Furthermore, the first mobile terminal and the second mobile terminal, and, moreover, 3 or more mobile terminals may each be connected to a storage terminal in different methods.

In case the first mobile terminal and the second mobile terminal have completed preparation for transmitting content based upon the set-up information, the content transmission between the first mobile terminal and the second mobile terminal may be realized as described below. First of all, in case the first mobile terminal is in a state of being connected to a second terminal through a broadband network, content may be transmitted through the pre-connected broadband network. For example, in case a video conference is being held through a broadband network, content may be transmitted by being added to the transmission of the voice and video for the video conference. In case it is determined that content cannot be transmitted through the pre-connected link based upon the set-up information, content may be transmitted through a new link for content transmission. Additionally, instead of the pre-connected link, the first mobile terminal may determine the second storage terminal as the new link and may directly transmit the content to the second storage terminal. Furthermore, instead of the pre-connected link with the first mobile terminal, the second mobile terminal may also receive content through a new link, which is directly connected to the first storage terminal.

### First Embodiment

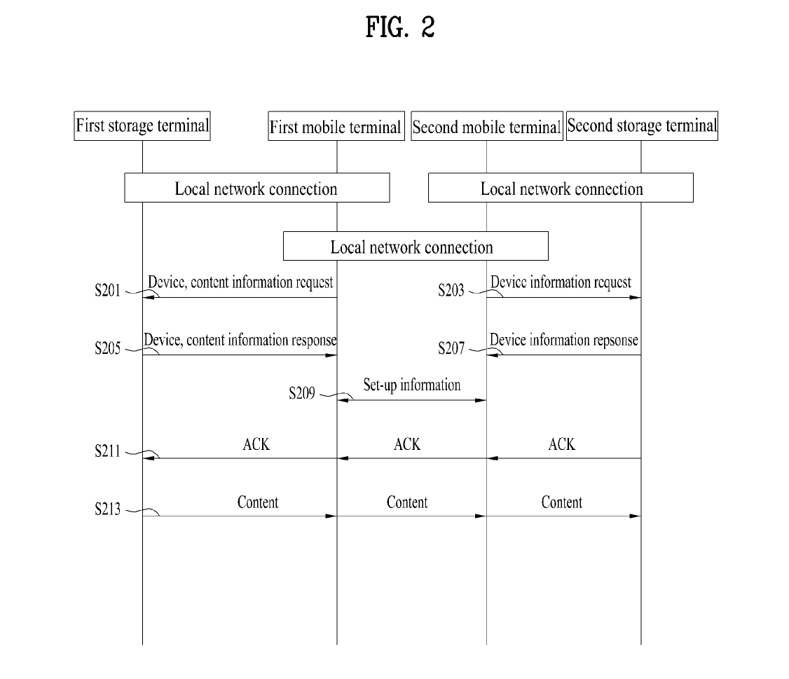

FIG. 2 illustrates a flow chart showing a content transmitting method according to a first exemplary embodiment of the present invention.

Hereinafter, the first exemplary embodiment of the present invention will be described in detail with reference to FIG. 2.

First of all, a first mobile terminal and a second mobile terminal verify whether or not content that is to be transmitted/receives exists in a state when a pre-connected link is maintained.

Based upon the verified result, when content transmission is requested, the first mobile terminal transmits a device and content information request message to a first storage terminal, which is storing content (S201). The device and content information request message corresponds to a message that identifies content and that requests for information for identifying the first storage terminal, which is storing the content. Similarly, the second mobile terminal may transmit a device information request message to a second storage terminal (S203).

As a response to the request, the first storage terminal transmits a device and content information response message to the first mobile terminal (S205). Similarly, the second storage terminal may transmit a device information response message to the second mobile terminal (S207). Herein, step S201 to step S207 may be realized in a communication format, such as NFC, Zigbee, Bluetooth, Wi-Fi Direct, or may be realized in a format having the first mobile terminal scan (read) a code or tag of the first storage terminal, such as a QR code, a barcode, an RFID tag.

Subsequently, the first mobile terminal transmits/receives set-up information to/from the second mobile terminal (S209). As described above, the set-up information may include at least one of information on a terminal that is to participate in content transmission, information on the content that is being transmitted, and information on a pre-connected link. Similarly, the second mobile terminal may also transmit set-up information including the device information response information, which is received from the second storage terminal, to the first mobile terminal. The first mobile terminal determines whether or not the content can be transmitted through the pre-connected link between the first mobile terminal and the second mobile terminal based upon the information received from the first storage terminal and the information received from the second mobile terminal. At this point, if the content cannot be transmitted through the pre-connected link, the preparation for the content transmission are cancelled and only the function being performed in the pre- connected link is performed.

If content transmission through the pre-connected link can be performed, and ACK (acknowledgement) procedure may be performed (S211). The ACK procedure may be transmitted by both the first storage terminal and the second storage terminal, or may be transmitted by only one of the first storage terminal and the second storage terminal. FIG. 2 shows an example of having the second storage terminal transmit an ACK message to the first storage terminal through the second mobile terminal and the first mobile terminal. Additionally, the ACK message may be directly transmitted to the first storage terminal from the second storage terminal without passing through the first mobile terminal and the second mobile terminal.

Subsequently, after the ACK procedure is performed, the first mobile terminal transmits the content, which is received from the second storage terminal through the second mobile terminal, to the first storage terminal (S213). At this point, the first mobile terminal may transmit content through a pre-connected link while performing a function that has already been performed through the pre-connected link (e.g., video conference) at the same time. Furthermore, in case the ACK procedure is omitted, the S211 procedure is performed, and, after a predetermined period of time, or immediately, the first terminal may attempt to receive content.

### Second Embodiment

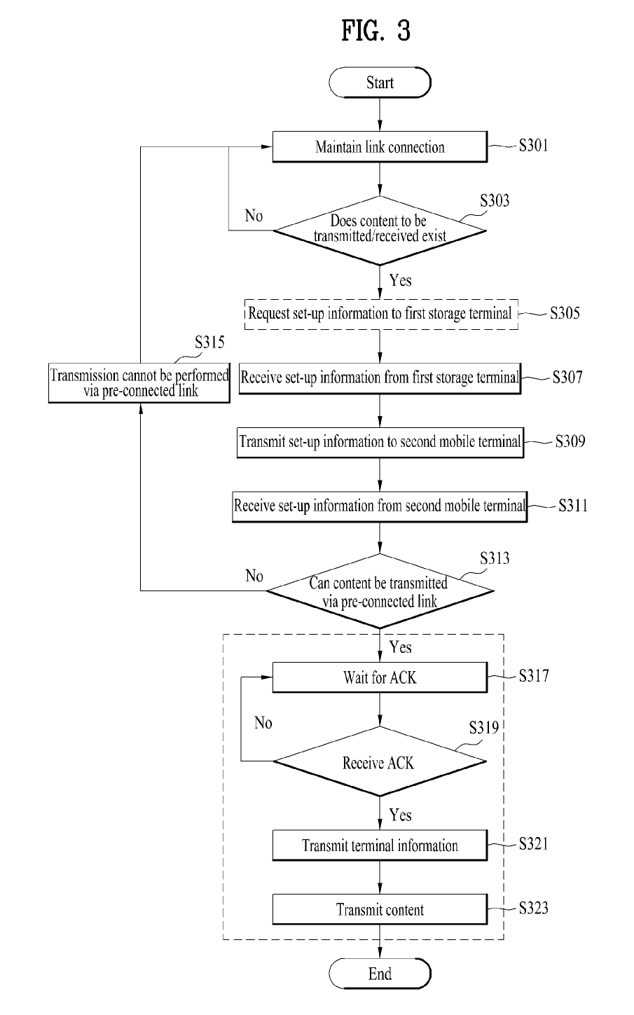

FIG. 3 illustrates a flow chart showing a content transmitting method according to a second exemplary embodiment of the present invention. More specifically, the second exemplary embodiment shows the exemplary embodiment of the present invention that is performed by a first mobile terminal.

Referring to FIG. 3, first of all, while being in a state of maintaining a pre-connected link (S301), a first mobile terminal verifies whether or not content that is to be transmitted/receives exists (S303).

Based upon the verified result, in case content that is to be transmitted/received exists, the first mobile terminal requests for set-up information that is required for performing the content transmission to a first storage terminal (S305). As described above, the set-up information may include at least one of information on a terminal that is to participate in content transmission, information on the content that is being transmitted, and information on a pre-connected link. Additionally, step S305 may perform a role of triggering the process steps that are realized after step S305.

As a response to step S305, the first mobile terminal receives set-up information from the first storage terminal (S307). Herein, step S301 to step S307 may be realized in a communication format, such as NFC, Zigbee, Bluetooth, Wi-Fi Direct, or may be realized in a format having the first mobile terminal scan (read) a code or tag of the first storage terminal, such as a QR code, a barcode, an RFID tag. In this case, while performing scanning, the first mobile terminal may transmit a message, which notifies that information on the second storage terminal will be transmitted to the first storage terminal, to the first storage terminal at the same time.

Subsequently, the first mobile terminal transmits set-up information including information on the first storage terminal to the second mobile terminal (S309). As described above, the set-up information may include at least one of information on a terminal that is to participate in content transmission, information on the content that is being transmitted, and information on a pre-connected link. Additionally, the first mobile terminal receives set-up information including information on the second storage terminal from the second mobile terminal (S311).

Thereafter, the first mobile terminal determines whether or not the content can be transmitted through the pre-connected link between the first mobile terminal and the second mobile terminal based upon the information received from the first storage terminal and the information received from the second mobile terminal (S313). At this point, if the content cannot be transmitted through the pre-connected link, the preparation for the content transmission are cancelled and only the function being performed in the pre-connected link is performed (S315).

If content transmission through the pre-connected link can be performed, the first mobile terminal waits for the reception of an ACK (acknowledgement) message from the second mobile terminal (S317).

When the ACK message is received, the first mobile terminal transmits information on the first storage terminal to the second storage terminal through the second mobile terminal (S319).

Finally, the first mobile terminal transmits content to the second mobile terminal (S323).

### Third Embodiment

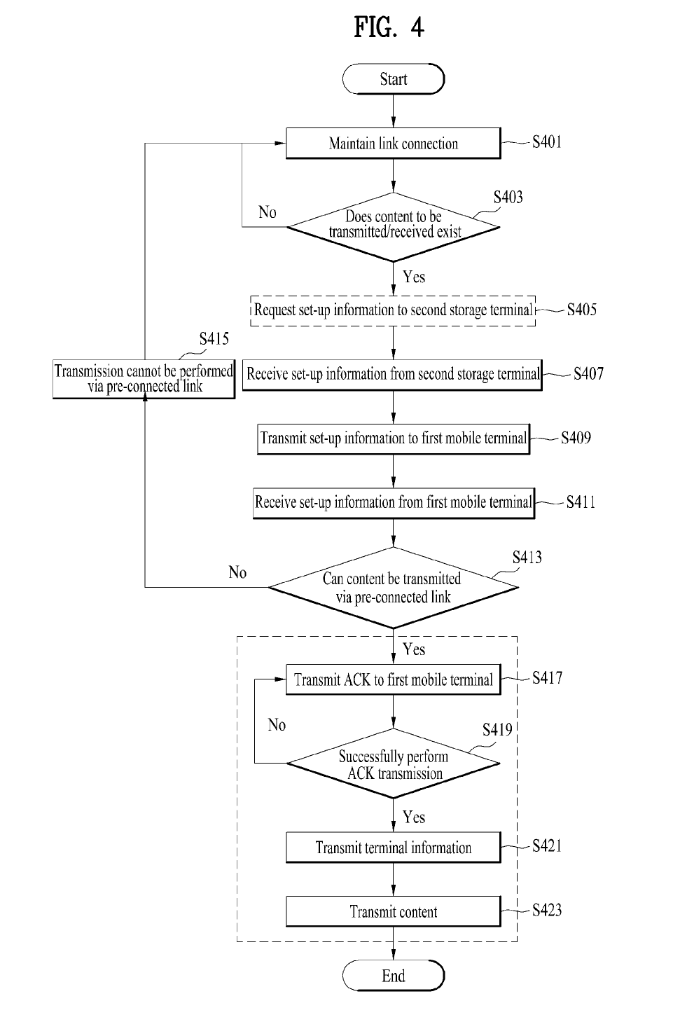

FIG. 4 illustrates a flow chart showing a content transmitting method according to a third exemplary embodiment of the present invention. More specifically, the third exemplary embodiment shows the exemplary embodiment of the present invention that is performed by a second mobile terminal.

Referring to FIG. 4, first of all, while being in a state of maintaining a pre-connected link (S401), a second mobile terminal verifies whether or not content that is to be transmitted/receives exists (S403).

Based upon the verified result, in case content that is to be transmitted/received exists, the second mobile terminal requests for set-up information that is required for performing the content transmission to a second storage terminal (S405). As described above, the set-up information may include at least one of information on a terminal that is to participate in content transmission/reception and information on a pre-connected link.

As a response to step S405, the second mobile terminal receives set-up information from the second storage terminal (S407). Herein, step 5401 to step S407 may be realized in a communication format, such as NFC, Zigbee, Bluetooth, Wi-Fi Direct, or may be realized in a format having the first mobile terminal scan (read) a code or tag of the first storage terminal, such as a QR code, a barcode, an RFID tag.

Subsequently, the second mobile terminal transmits set-up information including information on the second storage terminal to the first mobile terminal (S409). As described above, the set-up information may include at least one of information on a terminal that is to participate in content transmission, information on the content that is being transmitted, and information on a pre-connected link. Additionally, the second mobile terminal receives set-up information including information on the first storage terminal from the first mobile terminal (S411).

Thereafter, the second mobile terminal determines whether or not the content can be transmitted through the pre-connected link between the second mobile terminal and the first mobile terminal based upon the information received from the second storage terminal and the information received from the first mobile terminal (S413). At this point, if the content cannot be transmitted through the pre-connected link, the preparation for the content transmission are cancelled and only the function being performed in the pre-connected link is performed (S415).

If content transmission through the pre-connected link can be performed, the second mobile terminal transmits an ACK (acknowledgement) message to the first mobile terminal (S417).

When the transmission of the ACK message is successfully performed (S419), the second mobile terminal transmits information on the second storage terminal to the first storage terminal through the first mobile terminal (S421).

Finally, the second mobile terminal receives content from the first mobile terminal (S423).

### Fourth Embodiment

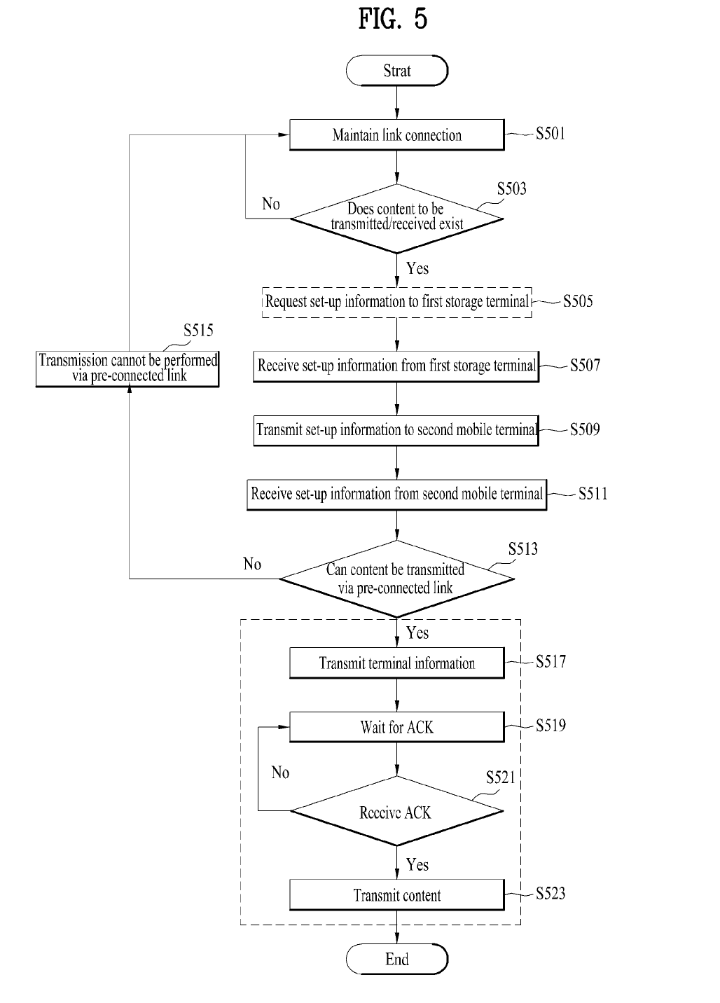

FIG. 5 illustrates a flow chart showing a content transmitting method according to a fourth exemplary embodiment of the present invention. More specifically, the fourth exemplary embodiment shows the exemplary embodiment of the present invention that is performed by a first mobile terminal, and, in the second exemplary embodiment, the ACK transmission order of S517 to S521 is changed.

Referring to FIG. 5, first of all, while being in a state of maintaining a pre-connected link (S501), a first mobile terminal verifies whether or not content that is to be transmitted/receives exists (S503).

Based upon the verified result, in case content that is to be transmitted/received exists, the first mobile terminal requests for set-up information that is required for performing the content transmission to a first storage terminal (S505). As described above, the set-up information may include at least one of information on a terminal that is to participate in content transmission, information on the content that is being transmitted, and information on a pre-connected link. Additionally, step S505 may perform a role of triggering the process steps that are realized after step S505.

As a response to step S505, the first mobile terminal receives set-up information from the first storage terminal (S507). Herein, step S501 to step S507 may be realized in a communication format, such as NFC, Zigbee, Bluetooth, Wi-Fi Direct, or may be realized in a format having the first mobile terminal scan (read) a code or tag of the first storage terminal, such as a QR code, a barcode, an RFID tag. In this case, while performing scanning, the first mobile terminal may transmit a message, which notifies that information on the second storage terminal will be transmitted to the first storage terminal, to the first storage terminal at the same time.

Subsequently, the first mobile terminal transmits set-up information including information on the first storage terminal to the second mobile terminal (S509). As described above, the set-up information may include at least one of information on a terminal that is to participate in content transmission, information on the content that is being transmitted, and information on a pre-connected link. Additionally, the first mobile terminal receives set-up information including information on the second storage terminal from the second mobile terminal (S511).

Thereafter, the first mobile terminal determines whether or not the content can be transmitted through the pre-connected link between the first mobile terminal and the second mobile terminal based upon the information received from the first storage terminal and the information received from the second mobile terminal (S513). At this point, if the content cannot be transmitted through the pre-connected link, the preparation for the content transmission are cancelled and only the function being performed in the pre-connected link is performed (S515).

If content transmission through the pre-connected link can be performed, the first mobile terminal transmits information on the first storage terminal to the second storage terminal through the second mobile terminal (S517).

Afterwards, the first mobile terminal waits for the reception of an ACK (acknowledgement) message from the second mobile terminal (S519).

When the ACK message is received, the first mobile terminal transmits content to the second mobile terminal (S523).

### Fifth Embodiment

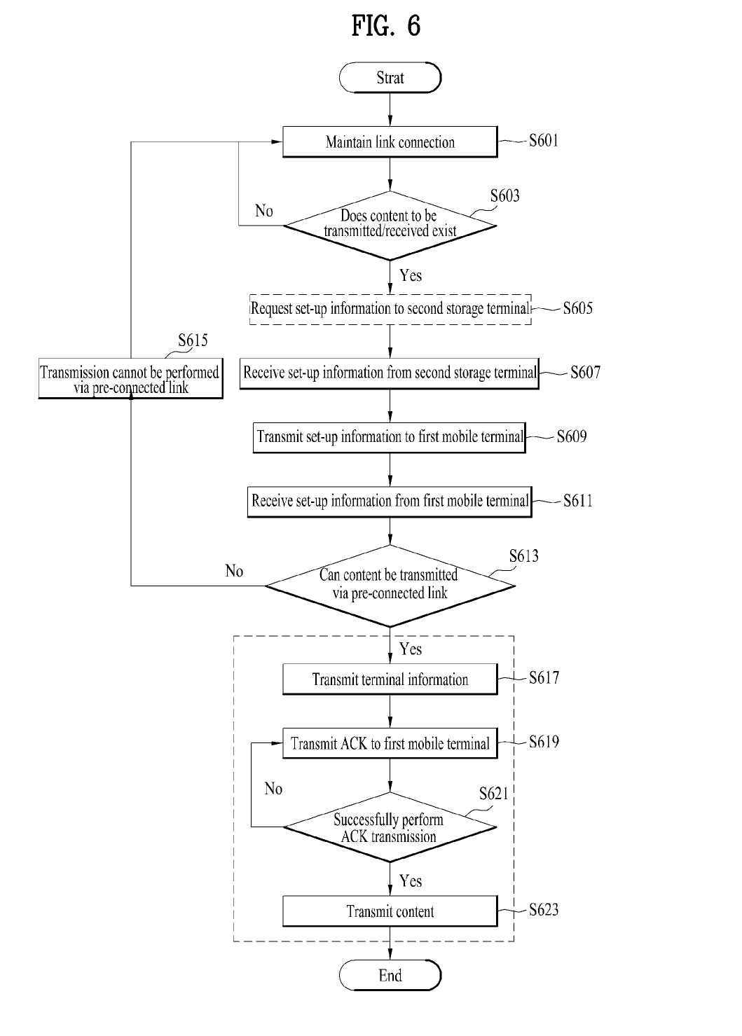

FIG. 6 illustrates a flow chart showing a content transmitting method according to a fifth exemplary embodiment of the present invention. More specifically, the fifth exemplary embodiment shows the exemplary embodiment of the present invention that is performed by a second mobile terminal, and, in the third exemplary embodiment, the ACK transmission order of S617 to S621 is changed.

Referring to FIG. 6, first of all, while being in a state of maintaining a pre-connected link (S601), a second mobile terminal verifies whether or not content that is to be transmitted/receives exists (S603).

Based upon the verified result, in case content that is to be transmitted/received exists, the second mobile terminal requests for set-up information that is required for performing the content transmission to a second storage terminal (S605). As described above, the set-up information may include at least one of information on a terminal that is to participate in content transmission, information on the content that is being transmitted, and information on a pre-connected link.

As a response to step S605, the second mobile terminal receives set-up information from the second storage terminal (S607). Herein, step S601 to step S607 may be realized in a communication format, such as NFC, Zigbee, Bluetooth, Wi-Fi Direct, or may be realized in a format having the first mobile terminal scan (read) a code or tag of the first storage terminal, such as a QR code, a barcode, an RFID tag.

Subsequently, the second mobile terminal transmits set-up information including information on the second storage terminal to the first mobile terminal (S609). As described above, the set-up information may include at least one of information on a terminal that is to participate in content transmission, information on the content that is being transmitted, and information on a pre-connected link. Additionally, the second mobile terminal receives set-up information including information on the first storage terminal from the first mobile terminal (S611).

Thereafter, the second mobile terminal determines whether or not the content can be transmitted through the pre-connected link between the second mobile terminal and the first mobile terminal based upon the information received from the second storage terminal and the information received from the first mobile terminal (S613). At this point, if the content cannot be transmitted through the pre-connected link, the preparation for the content transmission are cancelled and only the function being performed in the pre-connected link is performed (S615).

If content transmission through the pre-connected link can be performed, the second mobile terminal transmits information on the second storage terminal to the first storage terminal through the first mobile terminal (S617).

Thereafter, the second mobile terminal transmits an ACK (acknowledgement) message to the first mobile terminal (S619).

When the transmission of the ACK message is successfully performed (S621), the second mobile terminal receives content from the first mobile terminal (S623).

### Sixth Embodiment

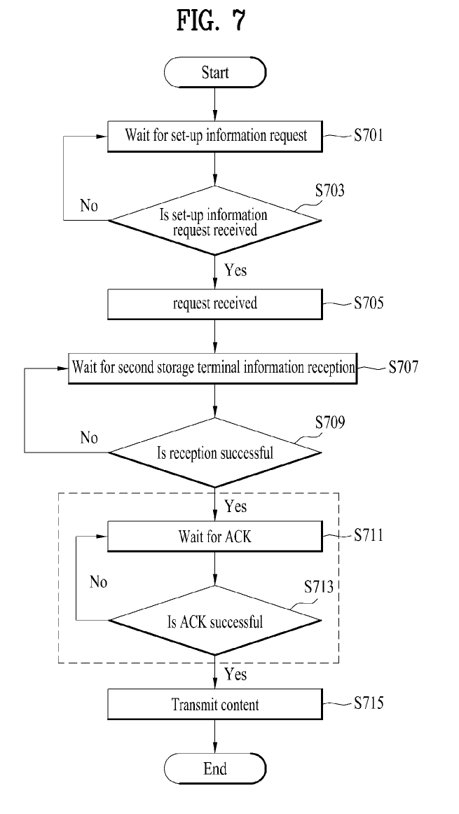

FIG. 7 illustrates a flow chart showing a content transmitting method according to a sixth exemplary embodiment of the present invention. More specifically, the sixth exemplary embodiment shows the exemplary embodiment of the present invention that is performed by a first mobile terminal.

Referring to FIG. 7, first of all, a first storage terminal waits for a request for set-up information from a first mobile terminal (S701). At this point, in case the request is realized in a format of having the first mobile terminal scan (read) a code or tag of the first storage terminal, the first storage terminal may wait for a message, which notifies that information on the second storage terminal will be received.

When the request for the set-up information is received from the first mobile terminal (S703), the first storage terminal transmits set-up information, which includes information the stored content and information on the first storage terminal, to the first mobile terminal (S705).

Thereafter, the first storage terminal waits for the reception of the information on the second storage terminal from the first mobile terminal (S707).

In case the information on the second storage terminal is received (S709), the first storage terminal waits for an ACK message of the second storage terminal (S711). At this point, the ACK message, which is transmitted from the second storage terminal, may be transmitted to the first storage terminal by sequentially passing though the second mobile terminal and the first mobile terminal. Moreover, the ACK message may be directly transmitted to the first storage terminal from the second storage terminal through a link, which is directly connected from the second storage terminal to the first storage terminal.

When the first storage terminal receives the ACK message of the second storage terminal through the first mobile terminal (S713), the first storage terminal transmits content to the first mobile terminal (S715).

### Seventh Embodiment

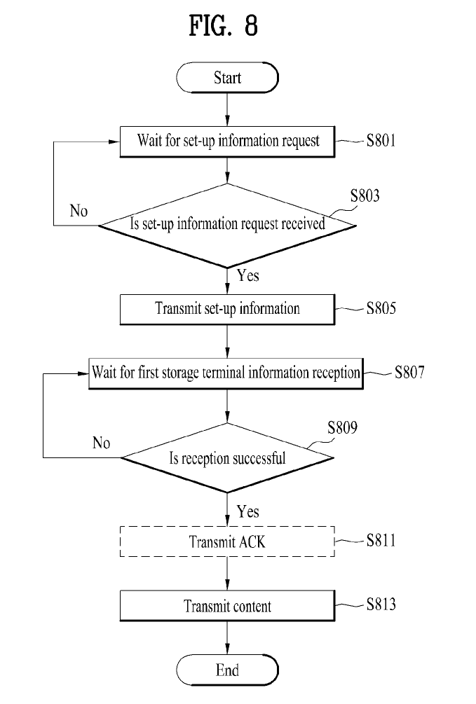

FIG. 8 illustrates a flow chart showing a content transmitting method according to a seventh exemplary embodiment of the present invention. More specifically, the seventh exemplary embodiment shows the exemplary embodiment of the present invention that is performed by a second mobile terminal.

Referring to FIG. 8, first of all, a second storage terminal waits for a request for set-up information from a second mobile terminal (S801). At this point, in case the request is realized in a format of having the second mobile terminal scan (read) a code or tag of the first storage terminal, the second storage terminal may wait for a message, which notifies that information on the second storage terminal will be received.

When the request for the set-up information is received from the second mobile terminal (S803), the set-up information, which includes information on the second storage terminal, is transmitted to the second mobile terminal (S805).

Thereafter, the second storage terminal waits for the reception of the information on the first storage terminal from the second mobile terminal (S807).

In case the information on the first storage terminal is received (S809), the second storage terminal transmits an ACK message to the first storage terminal (S811). At this point, the ACK message, which is transmitted to the first storage terminal, may be transmitted to the first storage terminal by sequentially passing though the second mobile terminal and the first mobile terminal. Moreover, the ACK message may be directly transmitted to the first storage terminal from the second storage terminal through a link, which is directly connected from the second storage terminal to the first storage terminal.

Finally, the second storage terminal transmits content to the second mobile terminal (S813).

### Eighth Embodiment

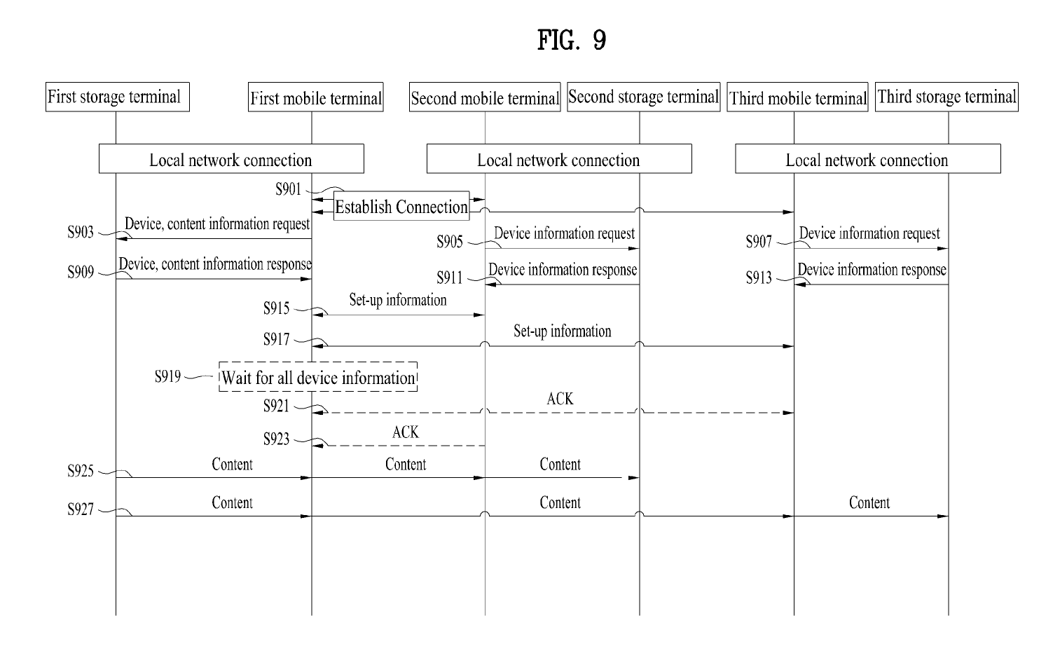

FIG. 9 illustrates a flow chart showing a content transmitting method according to an eighth exemplary embodiment of the present invention. More specifically, the eighth exemplary embodiment shows the exemplary embodiment of the present invention that is performed by 3 mobile terminals.

Hereinafter, the eighth exemplary embodiment of the present invention will be described in detail with reference to FIG. 9.

First of all, each of a first mobile terminal to a third mobile terminal verifies whether or not content that is to be transmitted/receives exists in a state when a pre-connected link is maintained. Additionally, the first mobile terminal and the second mobile terminal or the first mobile terminal and the third mobile terminal may verify configurations of the connected link (S901).

Based upon the verified result, when content transmission is requested, the first mobile terminal transmits a device and content information request message to a first storage terminal, which is storing content (S902). The device and content information request message corresponds to a message that identifies content and that requests for information for identifying the first storage terminal, which is storing the content. The second mobile terminal may transmit a device information request message to a second storage terminal (S905). Similarly, the third mobile terminal may transmit a device information request message to a third storage terminal (S907).

As a response to the request, the first storage terminal transmits a device and content information response message to the first mobile terminal (S909). Similarly, the second storage terminal may transmit a device information response message to the second mobile terminal, and the third storage terminal may transmit a device information response message to the third mobile terminal (S911, S913). Herein, step S903 to step S913 may be realized in a communication format, such as NFC, Zigbee, Bluetooth, Wi-Fi Direct, or may be realized in a format having the first mobile terminal scan (read) a code or tag of the first storage terminal, such as a QR code, a barcode, an RFID tag.

Subsequently, the first mobile terminal transmits/receives set-up information to/from each of the second mobile terminal and the third mobile terminal (S915, S917). As described above, the set-up information may include at least one of information on a terminal that is to participate in content transmission, information on the content that is being transmitted, and information on a pre-connected link. Similarly, each of the second mobile terminal and the third mobile terminal also transmits set-up information including the device information response information, which is respectively received from the second storage terminal and the third storage terminal, to the first mobile terminal. The first mobile terminal waits for the first to third mobile terminals to transmit/receive the set-up information (S919), and, when the transmission/reception is completed, the first mobile terminal determines whether or not the content can be transmitted through the pre-connected link based upon the information received from the first storage terminal, the information received from the second mobile terminal, and the information received from the third mobile terminal. At this point, if the content cannot be transmitted through the pre-connected link, the preparation for the content transmission are cancelled and only the function being performed in the pre-connected link is performed.

If content transmission through the pre-connected link can be performed, and ACK (acknowledgement) procedure may be performed. More specifically, the first mobile terminal may receive an ACK message from the second mobile terminal (S921), and the first mobile terminal may also receive an ACK message from the third mobile terminal (S923).

Subsequently, after the ACK procedure is performed, the first mobile terminal transmits the content to the first storage terminal through the second mobile terminal (S925). Additionally, the first mobile terminal transmits the content to the third storage terminal through the third mobile terminal (S927). At this point, the first mobile terminal may transmit content through a pre-connected link while performing a function that has already been performed through the pre-connected link (e.g., video conference) at the same time. Furthermore, in case the ACK procedure is omitted, the S919 procedure is performed, and, after a predetermined period of time, or immediately, the first terminal may attempt to receive content.

### Ninth Embodiment

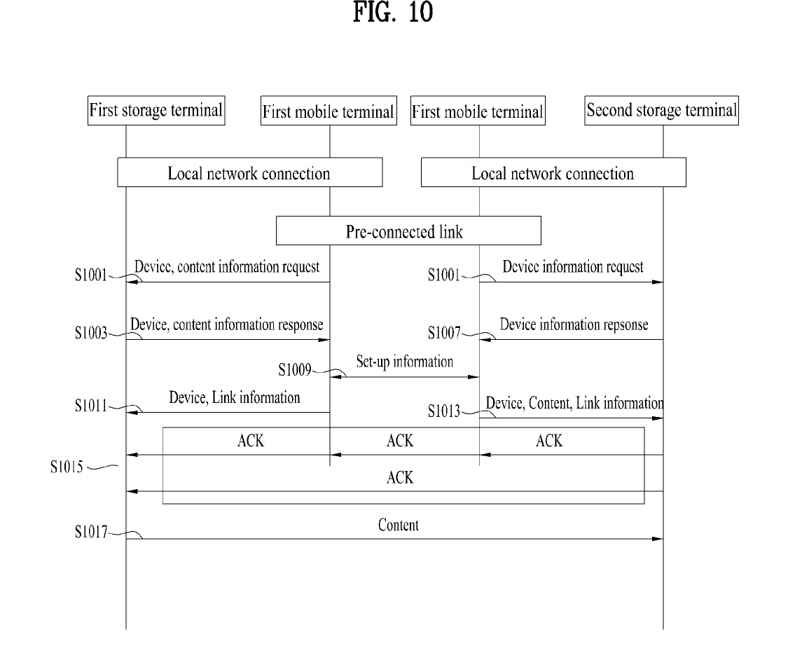

FIG. 10 illustrates a flow chart showing a content transmitting method according to a ninth exemplary embodiment of the present invention. More specifically, the ninth exemplary embodiment shows the exemplary embodiment of the present invention that is performed when content transmission cannot be performed through a pre-connected link.

Hereinafter, the ninth exemplary embodiment of the present invention will be described in detail with reference to FIG. 10. Referring to FIG. 10, since step S1001 to step S1009 of FIG. 10 are identical to S201 to S209 of FIG. 2, detail description of the same will be omitted.

After performing up to S1009, when the first mobile terminal transmits/receives set-up information to/from the second mobile terminal, the first mobile terminal determines whether or not content transmission can be performed based upon information received from the first storage terminal and information received from the second mobile terminal. The ninth exemplary embodiment of the present invention shows a case when the first mobile terminal has determined that content cannot be transmitted through the pre-connected link.

Subsequently, the first mobile terminal transmits information on a device and a new link, which is to transmit the content, to the first storage terminal (S1011). Additionally, the second mobile terminal transmits information on a device, content, and a new link, which is to transmit the content, to the second storage terminal (S1013).

Thereafter, an ACK procedure is performed (S1015). For example, the second storage terminal may transmit an ACK message to the first storage terminal by sequentially passing though the second mobile terminal and the first mobile terminal. Additionally, the second storage terminal may also directly transmit an ACK message through a link that is newly established with the first storage terminal.

Finally, the first storage terminal transmits content through a link that is newly established between the first storage terminal and the second storage terminal (S1017).

### Tenth Embodiment

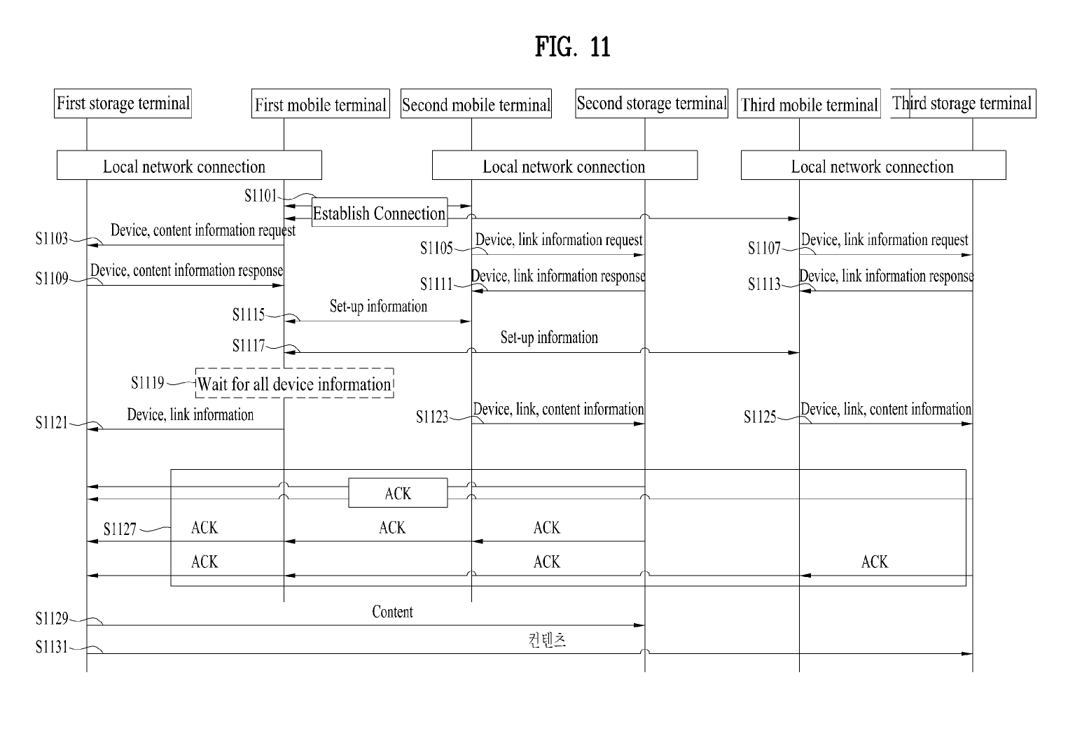

FIG. 11 illustrates a flow chart showing a content transmitting method according to a tenth exemplary embodiment of the present invention. More specifically, the tenth exemplary embodiment shows the exemplary embodiment of the present invention that is performed, when 3 mobile terminals are used, and when content transmission cannot be performed through a pre-connected link.

Hereinafter, the tenth exemplary embodiment of the present invention will be described in detail with reference to FIG. 11. Referring to FIG. 11, since step S1101 to step S1117 of FIG. 11 are identical to S901 to S917 of FIG. 9, detail description of the same will be omitted.

After performing up to S1117, when the first mobile terminal transmits/receives set-up information to/from the second mobile terminal and the third mobile terminal, the first mobile terminal determines whether or not content transmission can be performed based upon information received from the first storage terminal and information received from the second mobile terminal. The tenth exemplary embodiment of the present invention shows a case when the first mobile terminal has determined that content cannot be transmitted through the pre-connected link.

Subsequently, the first mobile terminal transmits information on a device and a new link, which is to transmit the content, to the first storage terminal, the second mobile terminal transmits information on a device and a new link, which is to transmit the content, to the second storage terminal, and the third mobile terminal transmits information on a device and a new link, which is to transmit the content, to the third storage terminal (S1121, S1123, S1125).

Thereafter, an ACK procedure is performed (S1127). For example, the second storage terminal may transmit an ACK message to the first storage terminal by sequentially passing though the second mobile terminal and the first mobile terminal. Similarly, the third storage terminal may transmit an ACK message to the first storage terminal by sequentially passing though the third mobile terminal and the first mobile terminal. Additionally, the second storage terminal may also directly transmit an ACK message through a link that is newly established with the first storage terminal. Similarly, the third storage terminal may also directly transmit an ACK message through a link that is newly established with the first storage terminal.

Finally, the first storage terminal directly transmits content to the second storage terminal and the third storage terminal through a newly established link (S1129, S1131).

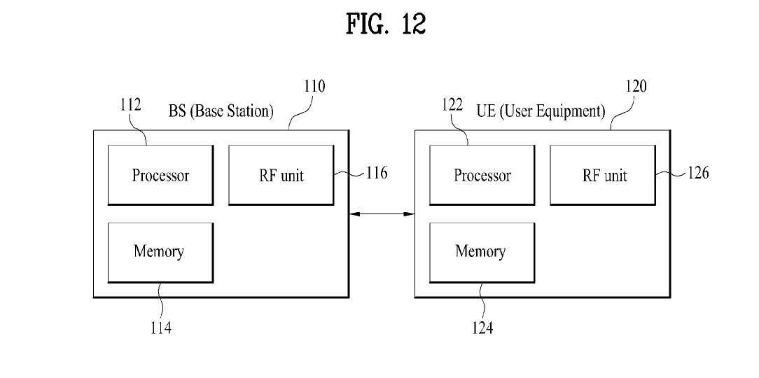

FIG. 12 illustrates a base station and a terminal that can be applied to an exemplary embodiment of the present invention.

Referring to FIG. 12, a wireless communication system includes a base station (BS, 110) and a user equipment (UE, 120). In a downlink, a transmitter corresponds to a part of the base station (110), and a receiver corresponds to a part of the user equipment (120). And, in an uplink, a transmitter corresponds to a part of the user equipment (120), and a receiver corresponds to a part of the base station (110). The base station (110) includes a processor (112), a memory (114), and a Radio Frequency (RF) unit (116). The processor (112) may be configured to realize the procedures and/or methods proposed in the present invention. The memory (114) is connected to the processor (112) and stores diverse information related to the operations of the processor (112). The RF unit (116) is connected to the processor (112) and transmits and/or receives radio signals. The user equipment (120) includes a processor (122), a memory (124), and an RF unit (126). The processor (122) may be configured to realize the procedures and/or methods proposed in the present invention. The memory (124) is connected to the processor (122) and stores diverse information related to the operations of the processor (122). The RF unit (126) is connected to the processor (122) and transmits and/or receives radio signals. The base station (110) and/or the user equipment (120) may have a single antenna or multiple antennae.

The embodiments described above correspond to predetermined combinations of elements and features and characteristics of the present invention. Moreover, unless mentioned otherwise, the characteristics of the present invention may be considered as optional features of the present invention. Herein, each element or characteristic of the present invention may also be operated or performed without being combined with other elements or characteristics of the present invention. Alternatively, the embodiment of the present invention may be realized by combining some of the elements and/or characteristics of the present invention. Additionally, the order of operations described according to the embodiment of the present invention may be varied. Furthermore, part of the configuration or characteristics of any one specific embodiment of the present invention may also be included in (or shared by) another embodiment of the present invention, or part of the configuration or characteristics of any one embodiment of the present invention may replace the respective configuration or characteristics of another embodiment of the present invention. Claims that do not have any explicit citations within the scope of the claims of the present invention may either be combined to configure another embodiment of the present invention, or new claims may be added during the amendment of the present invention after the filing for the patent application of the present invention.

In this document, the exemplary embodiments of the present invention have been described based upon a data transmission/reception relation between the terminal (or user equipment) and the base station. Occasionally, in this document, particular operations that are described as being performed by the base station may also be performed by its respective upper node. More specifically, in a network consisting of multiple network nodes including the base station, it is apparent that diverse operations that are performed in order to communicate with the terminal may be performed by the base station or b network nodes other than the base station. The term base station may be replaced by other terms, such as fixed station, Node B, eNode B (eNB), access point, and so on. Furthermore, the term terminal may be replaced by terms including UE (User Equipment), MS (Mobile Station), MSS (Mobile Subscriber Station), and so on.

The above-described embodiments of the present invention may be implemented by using a variety of methods, e.g., being realized in the form of hardware, firmware, or software, or in a combination of hardware, firmware, and/or software. In case of implementing the embodiments of the present invention in the form of hardware, the method according to the embodiments of the present invention may be implemented by using at least one of ASICs (application specific integrated circuits), DSPs (digital signal processors), DSPDs (digital signal processing devices), PLDs (programmable logic devices), FPGAs (field programmable gate arrays), processors, controllers, micro controllers, micro processors, and so on.

In case of implementing the embodiments of the present invention in the form of firmware or software, the method according to the embodiments of the present invention may be implemented in the form of a module, procedure, or function performing the above-described functions or operations. A software code may be stored in a memory unit and driven by a processor. Herein, the memory unit may be located inside or outside of the processor, and the memory unit may transmit and receive data to and from the processor by using a wide range of methods that have already been disclosed.

It will be apparent to anyone skilled in the art that the present invention can be realized in another concrete configuration (or formation) without deviating from the scope and spirit of the characteristics of the present invention. Therefore, in all aspect, the detailed description of present invention is intended to be understood and interpreted as an exemplary embodiment of the present invention without limitation. The scope of the present invention shall be decided based upon a reasonable interpretation of the appended claims of the present invention and shall come within the scope of the appended claims and their equivalents.

### INDUSTRIAL APPLICABILITY

The exemplary embodiments of the present invention may be applied to diverse wireless access systems. Examples of the diverse wireless access systems may include 3GPP (3rd Generation Partnership Project), 3GPP2, and/or IEEE 802 (Institute of Electrical and Electronic Engineers 802) systems, and so on. In addition to the diverse wireless access systems, the exemplary embodiments of the present invention may also be applied to all technical fields applying the diverse access systems.

What is claimed is:

1. As a method of a first mobile terminal being connected to a first storage terminal for transmitting data to a second storage terminal being connected to a second mobile terminal in a wireless access system, a method for transmitting/receiving data comprises:
a step of receiving information on the data being transmitted to the second storage terminal from the first storage terminal;
a step of transmitting information on the data to the second mobile terminal through a link being connected to the second mobile terminal;
a step of receiving information on the second storage terminal from the second mobile terminal through the link;
a step of determining whether or not the data transmission is capable of being performed through the link based upon the information on the data and the information on the second storage terminal; and
when the data transmission is capable of being performed, a step of transmitting the data being received from the first storage terminal to the second mobile terminal through the link.

2. The method of claim 1, wherein the step of transmitting data comprises:
a step of transmitting the data through the link along with pre-existing data, the already-existing data being configured for a function already being performed through the link.

3. The method of claim 1, further comprising:
when data transmission is not capable of being performed through the link, a step of having the first storage terminal configure a new link being capable of transmitting the data to the second storage terminal.

4. The method of claim 1, wherein the first mobile terminal is connected to the first storage terminal through a first local network,
wherein the second mobile terminal is connected to the second storage terminal through a second local network, and
wherein the first mobile terminal is connected to the second mobile terminal through a broadband network.

5. The method of claim 1, wherein the first mobile terminal communicates with the first storage terminal through at least one of Wi-Fi Direct, NFC (near field communication), Zigbee, and bluethooth.

6. The method of claim 1, wherein the first mobile terminal acquires information on the data by reading a QR code (Quick Response Code) or a Barcode being attached to the first storage terminal.

7. The method of claim 1, wherein the first mobile terminal acquires information on the data by reading a RFID (Radio Frequency Identification) tag being attached to the first storage terminal by using a RFID reader.

8. The method of claim 1, wherein information on the data includes at least one of a file name of the data, a file size of the data, and a playback record of the data.

9. The method of claim 1, wherein, when the data transmission is capable of being performed, the step of transmitting data transmits the data after receiving an ACK (acknowledgement) message from the second storage terminal through the second mobile terminal.

10. As a mobile terminal configured to transmit data being stored in a first storage terminal to a second storage terminal being connected to a second mobile terminal, the mobile terminal comprises:
a radio frequency (RF) unit including a transmitter and a receiver; and
a processor,
wherein the processor is configured to:
receive information on the data that are to be transmitted to the second storage terminal from the first storage terminal,
transmit information on the data to the second mobile terminal through a link being connected to the second mobile terminal,
receive information on the second storage terminal from the second mobile terminal,
determine whether or not the data transmission is capable of being performed through the link based upon the information on the data and the information on the second storage terminal, and
transmit the data being received from the first storage terminal to the second mobile terminal through the link, when the data transmission is capable of being performed.

11. The mobile terminal of claim 10, wherein the data are transmitted through the link along with pre-existing data, the already-existing data being configured for a function already being performed through the link.

12. The mobile terminal of claim 10, wherein the first storage terminal is configured to establish a new link being capable of transmitting the data to the second storage terminal, when data transmission is not capable of being performed through the link.

13. The mobile terminal of claim 10, wherein the mobile terminal is connected to the first storage terminal through a first local network,
wherein the second mobile terminal is connected to the second storage terminal through a second local network, and
wherein the mobile terminal is connected to the second mobile terminal through a broadband network.

14. The mobile terminal of claim 10, wherein the first mobile terminal communicates with the first storage terminal through at least one of Wi-Fi Direct, NFC (near field communication), Zigbee, and bluethooth.

15. The mobile terminal of claim 10, wherein the first mobile terminal acquires information on the data by reading a QR code (Quick Response Code) or a Barcode being attached to the first storage terminal.
